(19) United States
(12) Patent Application Publication
(10) Pub. No.: US 2011/0282743 A1
(43) Pub. Date: Nov. 17, 2011

(54) ASSOCIATIVE ONLINE ADVERTISEMENT

(75) Inventors: Roger Gerdes, Maple Valley, WA (US); Theodore Parker, Redmond, WA (US)

(73) Assignee: BlingoBlango, Inc., Maple Valley, WA (US)

(21) Appl. No.: 12/781,665

(22) Filed: May 17, 2010

(51) Int. Cl. G06Q 30/00; G06Q 99/00

(52) U.S. Cl. 705/14.55

(57) ABSTRACT

Embodiments of methods and apparatuses for associative online advertisement are disclosed. In various embodiments, an online advertisement of a product or service provider may be selectively associated with a member of an online social network, under the selection control of the member. In various embodiments, the association enables at least another member of the online social network to select the online advertisement from a social media associated with the member to be likewise associated with the online advertisement, or purchase for the member, a product or service of the associated product or service provider. Other embodiments may be disclosed and/or claimed.

### TECHNICAL FIELD

Embodiments of the present disclosure relate to the field of online computing, more specifically, to methods and apparatuses for associative online advertisements, where online advertisements may be selectively associated with members of an online social network under the selection control of the members, allowing propagation of the online advertisements and/or enhancing effectiveness of the online advertisements to induce transactions with the online advertisers.

### BACKGROUND

Ever since the advent of the Internet, online advertisers have struggled to adapt to the new medium. More intelligent advertisement serving from content based, to user behavior based has been introduced to improve the effectiveness of online advertising. With the recent increased popularity of social networking sites, the issue has become even more complicated. However, current social networking sites provide little breakthrough, if any, in enhancing the effectiveness of online advertisements in inducing transactions with the online advertisers.

### SUMMARY

Embodiments of methods and apparatuses for associative online advertisements are disclosed. In various embodiments, an online advertisement of a product or service provider may be selectively associated with a member of an online social network, under the selection control of the member, allowing propagation of the online advertisements and enhancing effectiveness of the online advertisements to induce transactions with the online advertisers. In various embodiments, the association may enable at least another member of the online social network to select the online advertisement from a social media associated with the member to be likewise associated with the online advertisement, or purchase for the member, a product or service of the associated product or service provider/advertiser.

In various embodiments, the computing device may be configured to associate the online advertisement with the member in response to receipt of a selection of the online advertisement from a client device associated with the member. In various embodiments, the computing device may be configured to associate the online advertisement with the member by associating the online advertisement with a logical cork board and/or an online want list associated with the member.

In various embodiments, the computing device may be configured to show the logical cork board and/or the online want list to another client device associated with the another member of the online social network. In various embodiments, the computing device may be configured to show the logical cork board and/or the online want list as part of a social media associated with the member of the online social network.

In various embodiments, the computing device may be configured to likewise associate the online advertisement with the another member of the online social network, in response to receipt of a selection of the online advertisement off the shown logical cork board and/or want list, from another client device associated with the another member of the online social network. In various embodiments, the computing device may be configured to facilitate the another member to purchase for the member, the product or service of the product or service provider associated with the selected online advertisement off the shown logical cork board and/or online want list. In various embodiments, the computing device may be configured to facilitate the another member to purchase the product or service of the product or service provider associated with the selected online advertisement off the shown logical cork board and/or online want list, for the another member, a third party that is also a member of the online social network or a third party that is not a member of the online social network.

In various embodiments, the computing device may be configured to facilitate the client device of the member to interact with another computing device associated with a product or service provider associated with the online advertisement, to enable the member to purchase a product or service of the product or service provider associated with the online advertisement.

In various embodiments, the computing device may be configured to provide a search service that includes returning to the client device of the member, one or more online advertisements associated with a number of product or service providers, based at least in part on one or more search criteria of a search request, for selection by the member, for association with the member. In various embodiments, the computing device may be configured to pre-receive and pre-store the various online advertisements from computing devices associated with product or service providers/advertisers.

In various embodiments, the computing device may be configured to operate the logical cork board that includes the online want list. In various embodiments, the computing device may be configured to operate an online social network that includes the logical cork board.

In various embodiments, instructions configured to enable an apparatus, in response to execution of the instructions by the apparatus, to practice some or all aspects of the methods of the present disclosure, may be provided (and/or stored in a non-transitory computer-readable storage medium (e.g., a compact disk (CD), a digital video disk (DVD) and so forth).

### BRIEF DESCRIPTION OF THE DRAWINGS

Embodiments of the present disclosure will be described by way of exemplary embodiments, but not limitations, illustrated in the accompanying drawings in which like references denote similar elements, and in which:

FIG. 1 illustrates a network overview of the apparatuses of the present disclosure, in accordance with various embodiments;

FIGS. 2-3 illustrate flowchart views of various methods related to associative online advertisements, in accordance with various embodiments;

FIGS. 4-5 illustrate display views of various end user interface associated with associative online advertisements, in accordance with various embodiments;

FIG. 6 illustrates a flowchart view of various methods for propagating online advertisements and conducting online transactions via associative online advertisements, in accordance with various embodiments; and

FIG. 7 illustrates an example computer system, suitable for use to practice aspects of the present disclosure, in accordance with various embodiments.

### DETAILED DESCRIPTION OF ILLUSTRATIVE EMBODIMENTS

Illustrative embodiments of the present disclosure include but are not limited to methods and apparatuses for associative online advertisements. In various embodiments, an online advertisement of a product or service provider may be selectively associated with a member of an online social network, under the selection control of the member, allowing propagation of the online advertisements and enhancing effectiveness of the online advertisements to induce transactions with the online advertisers. Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C) or (A, B and C).” The phrase “(A) B” means “(B) or (A B)”, that is, A is optional.

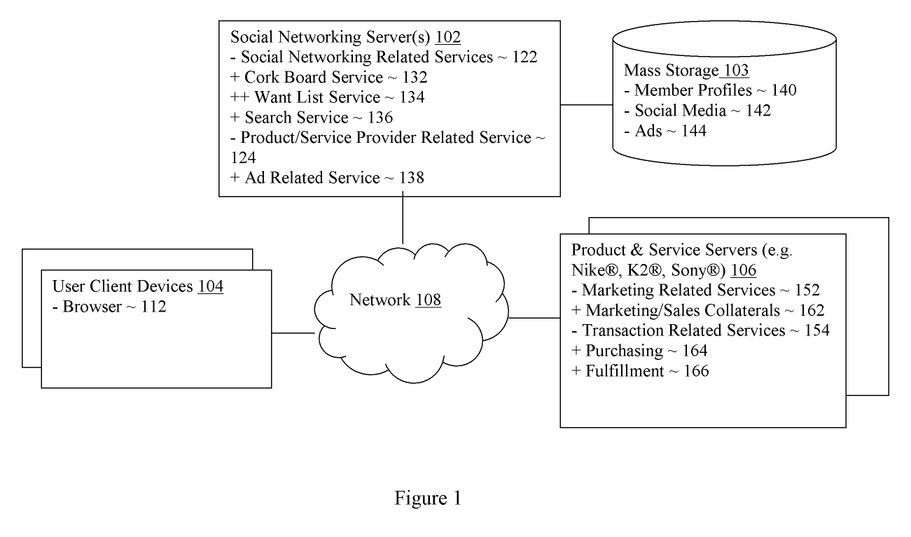

FIG. 1 illustrates a network overview of the apparatuses of the present disclosure, in accordance with various embodiments. As illustrated, computing device or devices (or servers) 102 associated with an online social network may be coupled with client devices 104 associated with members of the online social network, and computing devices (or servers) 106 associated with product or service providers/advertisers, via networks 108. In various embodiments, computing device or devices 102 may be configured to enable online advertisements of product or service providers to be selectively associated with members of the online social network, under the selection control of the members. In various embodiments, as will be described in more detail below, the association may enable at least another member of the online social network to select the online advertisement from a social media associated with the member, to be likewise associated with the online advertisement, thereby facilitating propagation of the online advertisements, or purchase for the member, a product or service of the associated product or service provider/advertiser, thereby potentially increasingly effectiveness of the online advertisements in inducing transactions with the online advertisers, i.e., the product or service providers.

For ease of understanding, hereinafter, terms like “online advertisements,” “online social network,” and “online advertisers,” will simply be referred to as “advertisements,” “social network,” and “advertisers,” however, unless the context clearly indicates otherwise, these terms are to be respectively considered synonymous, and to be so construed when the terms are used in the claims.

Continuing to refer to FIG. 1, in various embodiments, client devices 104 may be respectively configured with browsers 112. Client devices 104 are intended to represent a broad range of client devices known in the art, including but are not limited to, mobile or smart phones, personal digital assistants, tablet computers, laptop computers, and so forth. Browsers 112 are intended to represent a broad range of software applications known in the art for retrieving, presenting, and traversing information resources on the World Wide Web, including but are not limited to, Internet Explorer, available from Microsoft Corporation of Redmond, Wash., or Firefox, available from Mozilla Corporation of Mountain View, Calif.

In various embodiments, computing devices 106 may be configured with marketing or sales related services 152 and transaction related services 154. Marketing or sales related services 152 may include marketing/sales collaterals 162, such as web pages, downloadable brochures, and so forth, for providing information associated with products or services offered by the product or service providers/advertisers, or the product or service providers themselves, to inform and/or induce consumers in acquiring the products or services offered by the product or service providers/advertisers. Transaction related services 154 may include various purchasing 164 and/or fulfillment 166 related services, providing inventory, pricing, payment, delivery and other related services to enable products or services offered by the product or service providers/advertisers to be acquired. Computing devices 106 are intended to represent a broad range of computing servers known in the art, including but are not limited to servers available from IBM of Armonk, N.Y., or Dell Computer of Austin, Tex., as well as cloud computing services offered by Amazon of Seattle, Wash., and others.

Networks 108 are intended to represent a broad range of private and/or public, wired and/or wireless, wide area and/or local area networks. Public network may include e.g., the Internet. Wired networks may include e.g., Ethernet. Wireless networks may include e.g. WiFi. Wide area networks may include e.g., broadband networks offered by carriers and/or cable companies.

Still referring to FIG. 1, in various embodiments, computing device or devices 102 may be configured with social networking related services 122 and product/service provider related services 124. In various embodiments, social networking relates services 122, in addition to conventional social networking functions, such as user registration, user profile creation and management, creation, maintenance and sharing of user generated media (also referred to as social media), may include in particular, logical cork board service 132, want list service 134, and search service 136. In various embodiments, product/service provider related services 124, in addition to conventional product/service provider related function, such as product/service provider/advertiser registration, product/service provider/advertiser profile creation and management, may include in particular, ad related service 138 (ad=advertisement for short). Further, computing device or devices 102 may be associated with mass storage 103 having member profiles 140, members' social media 142, and advertisements 144 of product/service providers/advertisers.

In various embodiments, logical cork board (hereinafter simply “cork board”) service 132 may include services that enable a member to define and/or maintain an online cork board on one or more of the member's social media, attaching various visuals, such as photos, notes, or other interactive content, such as videos, audio clips, or web applications, to the logical cork board, similar or parallel to a physical cork board in the physical realm. In various embodiments, want list service 134 may include services that enable a member to attach in particular a logical list of wanted items to the member's cork board, similar or parallel to attaching a physical note to a physical cork board in the physical realm. In various embodiments, search services 136, in addition to conventional search services provided by search engines known in the art, may include searching of advertisements 144 collected and stored in mass storage 103 or on the Internet. These and other aspects of cork board services 132, want list services 134 and search services 136, including their inter-working with each other to provide the novel associative online advertisement of the present disclosure, will be further described below.

In various embodiments, ad related service 138 may include services related to collecting and storing product/service providers' ads 144 in mass storage, facilitating serving of the collected/stored ads 144 to client devices 104, facilitating member interactions, via client devices 104, with the served ads 144, and/or billing, invoicing, and/or collecting payments from the product/service providers/advertisers for the advertisement services provided, and/or transactions facilitated.

In various embodiments, ad related service 138 may be configured to bill, invoice and/or collect payments from the product/service providers/advertisers for the advertisement services provided, on a flat fee basis, on a per ad basis, or on a subscription type basis, with or without volume and other types of discount. In various embodiments, ad related service 138 may be configured to bill, invoice and/or collect payments from the product/service providers/advertisers for the advertisement services provided, in the conventional manner, e.g., number of times the advertisements are served, clicked, or resulting in transactions, with or without volume and other types of discount. For the embodiments where the billing, invoicing and/or payment collection is transaction based, the billing, invoicing and/or payment collection may also be transaction size based.

Similar to computing devices 106, computing device or devices 102 are intended to represent a broad range of computing servers known in the art, including but are not limited to servers available from IBM of Armonk, N.Y., or Dell Computer of Austin, Tex., as well as cloud computing services offered by Amazon of Seattle, Wash., and others.

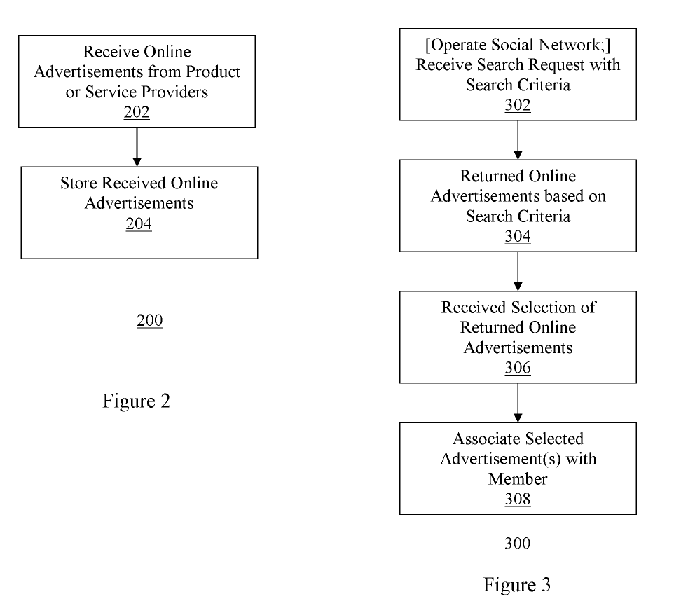

Referring now to FIGS. 2-3, wherein flowchart views of various methods related to associative online advertisements, in accordance with various embodiments, are shown. As illustrated in FIG. 2, an associative online advertisement method 200 may begin at block 202, with ad related services 138 of product/service provider related service 124 of computing device 102 receiving advertisements from the product or services providers/advertisers. In various embodiments, from block 202, the method may proceed to block 204, where ad related services 138 may store the received advertisements in mass storage 103. In various embodiments, method 200 may further include product/service provider related services 124 registering product/service providers/advertisers, facilitate creation and/or management of the product/service providers/advertisers' profiles.

As illustrated in FIG. 3, an associative online advertisement method 300 may begin at block 302, with social networking related services 122 of computing device 102 operating a social network for the network's members. The social network may be a general social network or a branded social network, e.g., for a particular sport, such as, but not limited to, football, baseball, basketball, golf, sailing and so forth. As described earlier, in various embodiments, the social networking services may include a search service 136. Thus, for these embodiments, search service 136, at block 302, may receive a search request from client device 104 associated with a member, having various search criteria.

In various embodiments, from block 302, the method may proceed to block 304, wherein search service 136 may return various advertisements to client device 104 of the member for selection and association with the member, based at least in part on the search criteria entered by the member. The returned advertisements may be retrieved from the stored advertisements 144 in mass storage 105, and/or advertisements retrieved from other sources, e.g., the Internet. From block 304, the method may proceed to block 306, wherein ad related services 138 may receive from client device 104 of the member, one or more selections of the returned advertisements by the member. From block 306, the method may proceed to block 308, wherein ad related services 138 may associate the selected one or more advertisements with the member.

Thus, unlike prior art, where advertisements are pushed to the client devices of the members, under the present disclosure, advertisements are advantageously pulled by the client devices of the members who desire association with the advertisements. Further, in the prior art, advertisements presented to the users are typically non-persistent across content, e.g., web-pages. Depending on particular ad campaigns, advertisements pushed to a viewer while consuming a content, may never be pushed to the same viewer again. However, under the present disclosure, associations are persistent, and remain associated with the member, as the member move from one social medium to another social medium, until the member decides to disassociate himself/herself with the previously associated advertisement.

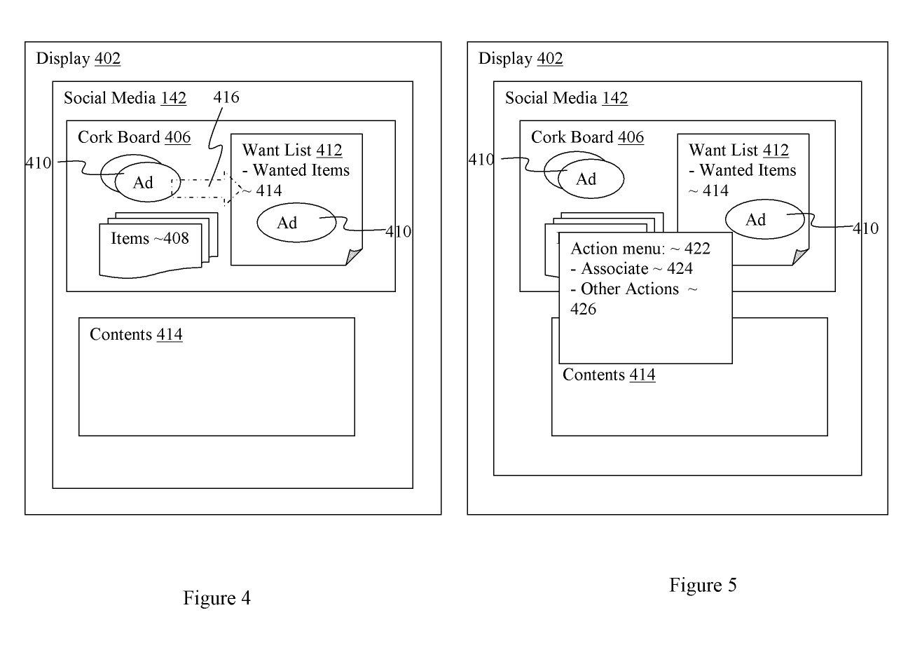

Referring now to FIGS. 4-5, wherein display views of various end user interfaces associated with associative online advertisements, in accordance with various embodiments, are shown. As illustrated, in various embodiments, social networking related services 122 may render a social media 142 having various contents 414 on display 402 of client device 104. For various social media 142, social networking related services 122 may further invoke cork board service 132 to render cork board 406 as part of social media 142. In response, cork board service 132 may render cork board 406 including cork board items 408 and associated advertisements (Ad) of the member 410. In various embodiments, in addition to various items 408 and associated advertisements 410, cork board service 132 may invoke want list service 134 to render want list 412. In response, want list service 134 may render want list 412, including wanted items 414, conventionally provided to want list 412, and advertisements 410 that have been designated as wanted items.

In various embodiments, cork board service 132 may be further configured to enable the member viewing social media 142 to interact with advertisements 410 in a conventional manner. The conventional interactions may include, for example, the member dragging 416 an associated advertisement 410 from the general area of cork board 406 and dropping 416 the dragged associated advertisement 410 in the want list 412 to denote a particular product or service of the product/service provider/advertiser, or its products/services in general, as a wanted item or wanted items, as illustrated in FIG. 4.

Additionally, in various embodiments, the conventional interactions may further include, for example, the member (or another member authorized to view social media 142) interacting with an associated advertisement 410 (designated or not designated as a wanted item), such as, clicking on the advertisement, and proceeding to interact with computing device 106 associated with the product/service provider/advertiser, directly or via servers 102, to view and/or gather further information about one or more products/services, and/or to acquire/purchase one or more products/services of the product/service provider/advertiser. The member/another member may acquire/purchase the product/service for the member/another member himself/herself or another third party, who may or may not be a member of the social network.

Further, in various embodiments, cork board service 132 and/or want list service 134 may, individually or in combination, support another (authorized) member viewing social media 412 to select the advertisement and have the advertisement be likewise associated with the another member. In various embodiments, cork board service 132 and/or want list service 134 may be configured to support, e.g., the another member right clicking on an advertisement 410, and in response, providing a pop-up action menu 422 including, other actions 426, and the action to associate the advertisement 410 with the another member.

In various embodiments, the conventional interactions may further include a member disassociating from a previously associated advertisement, e.g., through right clicking by the member, while a cursor is hovering over the previously associated advertisement, and selection of a “disassociation” option from a list of pop-up options.

Thus, under the present disclosure, a member may express his/her voluntary association with a product/service of a product/service provider/advertiser or the product/service provider/advertiser on his/her own cork board 406 and/or want list 412 to other members who are authorized to view the member's social media 142. Additionally, under the present disclosure, an advertisement may be virally propagated and be associated with multiple members through successive selection and association of the related members. Further, a member may express his/her desire for a product/service on his/her want list 412 to other members who are authorized to view the member's social media 142. Under the present disclosure, another member who is authorized to view a member's social media 142 (e.g., a grandparent of the member), upon seeing an associated advertisement as indicated as a wanted item, may purchase the related product or service for the member.

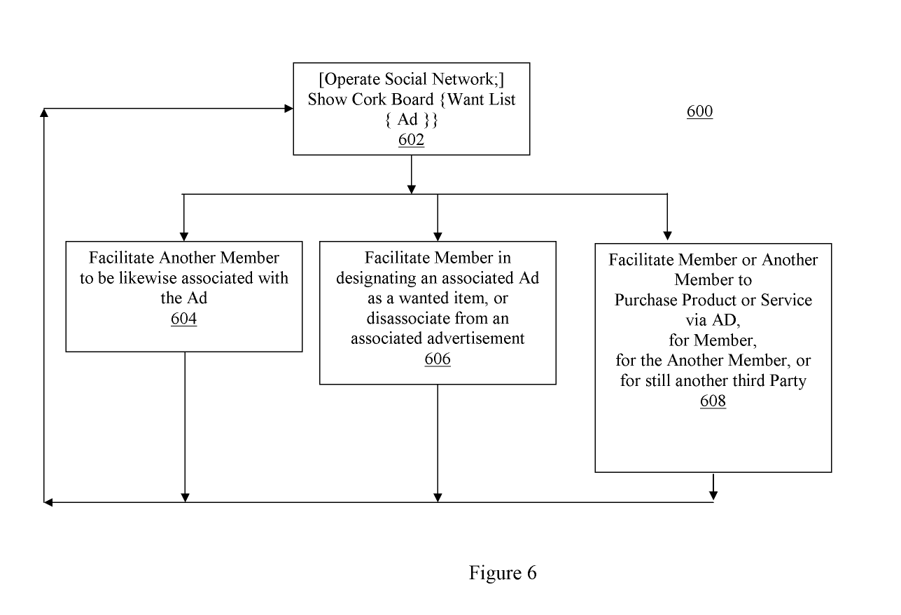

FIG. 6 illustrates a flowchart view of various methods for propagating online advertisements and conducting online transactions via associative online advertisements, in accordance with various embodiments. As illustrated, an associative online advertisement method 600 may begin at block 602, with social networking related services 122 of computing device 102 operating a social network for the network's members. As described earlier, in various embodiments, the social networking related services 122 may include cork board service 132 and want list service 134. In various embodiments. at block 602, cork board service 132 and want list service 134 may collaborate and render cork board 406 with want list 412, and associated advertisement 410, as described earlier.

In various embodiments, from block 602, method 600 may proceed to either block 604, block 606, or block 608. At block 604, cork board service 132 and want list service 134 may collaborate to support another (authorized) member viewing social media 142 to select and be likewise associated with one the advertisements 410. At block 606, cork board service 132 and want list service 134 may collaborate to support a member in designating a product and/or service associated with an advertisement 410 as a wanted item, or disassociate from a previously associated advertisement. At block 608, cork board service 132 and want list service 134 may collaborate to support the member or another (authorized) member viewing social media 142 to interact with computing device 106 of a product/service provider/advertiser to acquire/purchase a product or service for the member/another member himself, or a third party, which may be member or non-member of the social network. From either block 604, block 606, or block 608, method 600 may proceed and continue at block 602 as earlier described.

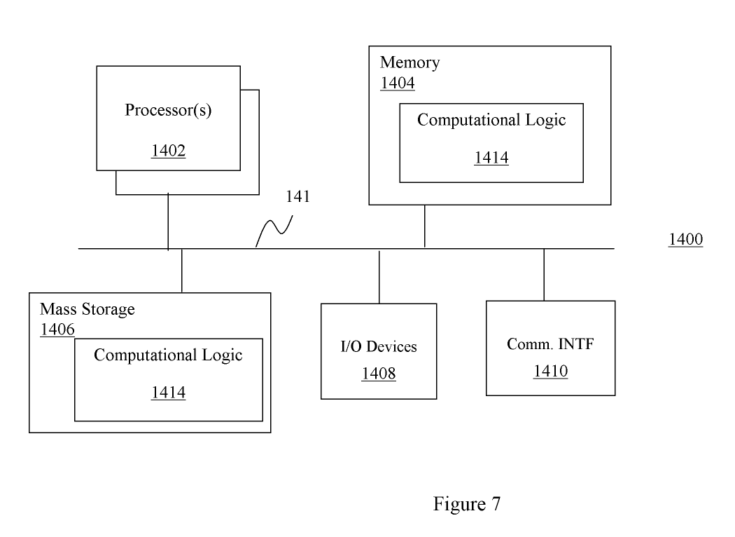

FIG. 7 illustrates an example computer system or computing device, suitable for use to practice aspects of the present disclosure, in particular, devices 102, in accordance with various embodiments. As shown, exemplary computing system or computing device 1400 includes one or more processors 1402 and system memory 1404. Additionally, system/device 1400 may include mass storage devices 1406 (such as diskette, hard drive, CDROM and so forth), input/output devices 1408 (such as keyboard, cursor control and so forth) and communication interfaces 1410 (such as network interface cards, modems and so forth). The elements may be coupled to each other via system bus 1412, which represents one or more buses. In the case of multiple buses, the buses may be bridged by one or more bus bridges (not shown).

Each of these elements performs its conventional functions known in the art. In particular, system memory 1404 and mass storage 1406 may be employed to store a working copy and a permanent copy of the programming instructions (computing logic 1414) and/or data, implementing the teachings of the present disclosure (e.g., earlier described social networking services 122 (including cork board services 132, want list service 134, and/or search service 136) and/or product/service provider related services 124 (including e.g., ad related services 138)). The programming instructions may be instructions of any one of a number of known or to be designed languages, including but are not limited to C, C++, Perl, Java, Javascript, XML, HTML and so forth. All or a portion of the permanent copy of the programming instructions/data may be loaded into mass storage 1406 in the factory, in the field (via a distribution medium) or through communication interface 1410 (from a distribution server (not shown)).

The constitution of elements 1402-1412 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present disclosure. This application is intended to cover any adaptations or variations of the embodiments discussed herein. Therefore, it is manifestly intended that this disclosure be limited only by the claims and the equivalents thereof.

What is claimed is:

1. A method comprising:
receiving from a client device associated with a member of an online social network, by a computing device associated with the online social network, a selection of an online advertisement associated with a product or service provider; and
associating in response to the receiving, by the computing device, the selected online advertisement with the member, wherein the associating enables at least another member of the online social network to select the online advertisement from a social media associated with the member to be likewise associated with the online advertisement, or purchase for the member, a product or service of the associated product or service provider.

2. The method as set forth in claim 1, wherein associating comprises associating by the computing device, the selected online advertisement with a logical cork board or an online want list associated with the member.

3. The method as set forth in claim 2, wherein associating comprises first associating by the computing device, the selected online advertisement with a logical cork board, then subsequently associating the selected online advertisement with an online want list associated with the member, in response to an input from the member.

4. The method as set forth in claim 2, further comprising showing the logical cork board or the online want list to another client device associated with the another member, by the computing device.

5. The method as set forth in claim 4, further comprising receiving from the another client device, by the computing device, a selection of the online advertisement off the shown logical cork board or online want list; and facilitating in response to the selection, by the computing device, the another client device to interact with another computing device associated with the product or service provider associated with the online advertisement, to enable the another member to purchase for the member, the product or service of the product or service provider associated with the selected online advertisement off the shown online want list.

6. The method as set forth in claim 5, wherein facilitating further comprises facilitating, by the computing device, the another client device to interact with the another computing device, to enable the another member to purchase a product or service of the product or service provider associated with the online advertisement, for the another member, a third party that is also a member of the online social network or a third party that is not a member of the online social network.

7. The method as set forth in claim 4, further comprising receiving from the another client device, by the computing device, a selection of the online advertisement off the shown logical cork board or online want list; and associating in response to the selection, by the computing device, the selected online advertisement with the another member in like manner as the online advertisement is associated with the member.

8. The method as set forth in claim 1, further comprising receiving from the client device, by the computing device, a selection of the online advertisement; and facilitating in response to the selection, by the computing device, the client device to interact with another computing device associated with a product or service provider associated with the online advertisement, to enable the member to purchase a product or service of the product or service provider associated with the online advertisement.

9. The method as set forth in claim 1, further comprising
receiving from the client device, by the computing device, a search request having one or more search criteria; and
returning to the client device, by the computing device, one or more online advertisements associated with a plurality of product or service providers, based at least in part on the one or more search criteria, for selection by the member to be associated with one or more of the returned online advertisements.

10. The method as set forth in claim 1, further comprising storing, by the computing device, the plurality of online advertisements associated with the plurality of product or service providers.

11. The method as set forth in claim 10, further comprising receiving from a plurality of computing devices associated with the plurality of product or service providers, by the computing device, the plurality of online advertisements associated with the product or service providers.

12. The method as set forth in claim 1, further comprising operating a logical cork board for the member, by the computing device, wherein the logical cork board includes the online want list.

13. The method as set forth in claim 12, further comprising operating the online social network by the computing device, wherein the online social network includes social media associated with the member, and one of the social media includes the logical cork board.

14. An apparatus comprising:
a processor; and
a computer-readable storage medium coupled with the processor, and having stored therein instructions configured to enable an apparatus associated with an online social network, in response to execution of the instructions by the processor, to
receive from a client device associated with a member of the online social network, a selection of an online advertisement associated with a product or service provider; and
associate in response to the receive, the selected online advertisement with the member, wherein the associating enables at least another member of the online social network to select the online advertisement from a social media associated with the member to be likewise associated with the online advertisement, or purchase for the member, a product or service of the associated product or service provider.

15. The apparatus as set forth in claim 14, wherein the instructions are configured to enable the apparatus, in response to execution of the instructions by the processor, to associate the selected online advertisement with a logical cork board or an online want list associated with the member.

16. The apparatus as set forth in claim 15, wherein the instructions are configured to enable the apparatus, in response to execution of the instructions by the processor, to first associate the selected online advertisement with a logical cork board, then subsequently associate the selected online advertisement with an online want list associated with the member, in response to an input from the member.

17. The apparatus as set forth in claim 15, wherein the instructions are configured to enable the apparatus, in response to execution of the instructions by the processor, to show the logical cork board or the online want list to another client device associated with the another member, by the computing device.

18. The apparatus as set forth in claim 17, wherein the instructions are configured to enable the apparatus, in response to execution of the instructions by the processor, to receive from the another client device, a selection of the online advertisement off the shown logical cork board or online want list; and facilitate in response to the selection, the another client device to interact with another computing device associated with the product or service provider associated with the online advertisement, to enable the another member to purchase for the member, the product or service of the product or service provider associated with the selected online advertisement off the shown online want list.

19. The apparatus as set forth in claim 18, wherein the instructions are configured to enable the apparatus, in response to execution of the instructions by the processor, to facilitate the another client device to interact with the another computing device, to enable the another member to purchase a product or service of the product or service provider associated with the online advertisement, for the another member, a third party that is also a member of the online social network or a third party that is not a member of the online social network.

20. The apparatus as set forth in claim 17, wherein the instructions are further configured to enable the apparatus, in response to execution of the instructions by the processor, to receive from the another client device, a selection of the online advertisement off the shown logical cork board or online want list; and associate in response to the selection, the selected online advertisement with the another member in like manner as the online advertisement is associated with the member.

21. The apparatus as set forth in claim 14, wherein the instructions are further configured to enable the apparatus, in response to execution of the instructions by the processor, to receive from the client device, a selection of the online advertisement; and facilitate in response to the selection, the client device to interact with another computing device associated with a product or service provider associated with the online advertisement, to enable the member to purchase a product or service of the product or service provider associated with the online advertisement.

22. The apparatus as set forth in claim 14, wherein the instructions are configured to enable the apparatus, in response to execution of the instructions by the processor, to receive from the client device, a search request having one or more search criteria; and
return to the client device, one or more online advertisements associated with a plurality of product or service providers, based at least in part on the one or more search criteria, for selection by the member to be associated with one or more of the returned online advertisements.

23. The apparatus as set forth in claim 14, wherein the instructions are further configured to enable the apparatus, in response to execution of the instructions by the processor, to operate a logical cork board for the member, wherein the logical cork board includes the online want list.

24. The apparatus as set forth in claim 25, wherein the instructions are further configured to enable the apparatus, in response to execution of the instructions by the processor, to operate the online social network wherein the online social network includes social media associated with the member, and one of the social media includes the logical cork board.

25. An article of manufacture, comprising:
a computer-readable storage medium; and
a plurality of instructions stored in the computer-readable storage medium, and configured to enable an apparatus associated with an online social network, in response to execution of the instructions by the apparatus, to perform operations including:
receiving from a client device associated with a member of the online social network, a selection of an online advertisement associated with a product or service provider; and
associating in response to the receive, the selected online advertisement with the member, wherein the associating enables at least another member of the online social network to select the online advertisement from a social media associated with the member to be likewise associated with the online advertisement, or purchase for the member, a product or service of the associated product or service provider.
